(19) United States
(12) Patent Application Publication
(10) Pub. No.: US 2022/0036490 A1
(43) Pub. Date: Feb. 3, 2022

(54) METHOD OF VALIDATING LEARNING OUTCOMES OF STUDENT

(71) Applicant: Key of David Consultants CO., LTD., Taipei (TW)

(72) Inventors: Chih-Wei CHAN, Taipei (TW); Tzu-Yi LIN, Taipei (TW)

(21) Appl. No.: 17/308,306

(22) Filed: May 5, 2021

(30) Foreign Application Priority Data
Aug. 3, 2020 (TW) 109126224

(51) Int. Cl. G06Q 50/20; G06Q 10/10

(52) U.S. Cl. CPC G06Q 50/205; G06Q 10/10

(57) ABSTRACT

A method of validating learning outcomes of a student is disclosed. In the method, a teaching application includes a validation program to determine an execution score and a completion rate for the student's execution result, the teaching application includes a task database storing task packages which are teaching contents previously taught to the student, and the task package include a sub-task package for the student to execute tasks, the sub-task package includes a validation program for acceptance of the execution result and statistics of an execution score and a completion rate. According to the insufficiency of the student in response to the student's execution score and the completion rate displayed on the teaching application, the teaching application automatically assigns the student to challenge the failed task again or assigns a remedial task to the student, so as to improve the student in knowledge or skills learned in course.

This application claims the priority benefit of Taiwan patent application number 109126224, filed on Aug. 3, 2020.

### BACKGROUND OF THE INVENTION

### 1. Field of the Invention

The present invention provides a method of validating learning outcomes of student. More particularly, the present invention provides a method of using a validation program of a teaching application to track the student's learning outcomes after courses, so as to achieve the purpose of harmony of knowledge and action.

### 2. Description of the Related Art

With coming of the era of knowledge economy, learners are keen on different knowledge; besides self-study using books, the Internet or related information, the more effective learning way is to participate in courses of schools or crams in which teachers teach knowledge or skills face-to-face with two-sided dialogues to increase the learner's knowledge and abilities. However, for busy modern learners, it is not easy to spend time in practicing the content taught in the course after finishing the teaching courses, so it causes that the learner spends a lot of money and time but the effect of learning is not as expected. Therefore, the above-mentioned issues often make a learner, who wants to study, lose willingness.

In view of the above-mentioned problems, the training needs to be gradually implemented in order to obtain better learning effect; otherwise, even if excellent and effective teaching courses are taught to the students, when the students are lazy or timid and not able to absorb and internalize the teaching contents, the student will stay in an inexperienced or a half-toned state. Therefore, what is needed is to develop a method to validate the learning outcomes of the student, so as to track the student's learning outcomes through a teaching application, thereby achieving harmony of knowledge and action.

### SUMMARY OF THE INVENTION

An objective of the present invention is to provide a method of validating learning outcomes of student, and in the method, a teaching application includes a validation program configured to determine an execution score and a completion rate for a student's execution result, the teaching application includes a task database, the task database stores task packages, the task packages correspond teaching contents previously taught to the student by a coach, and the task package includes a sub-task package configured for the student to execute tasks, the sub-task package includes a validation program configured for acceptance of the student's execution result and statistics of an execution score and a completion rate for the execution result. According to the insufficiency of the student in response to the student's execution score and the completion rate displayed on the teaching application, the teaching application is automatically preset to assign the student to challenge the failed task again or assign a remedial task to the student, so as to improve the student in knowledge or skills learned in course. As a result, the execution score and the completion rate are posted on the status wall of the webpage, the status wall includes a message box configured for student's peers to leave messages to cheer each other up, and the student's learning outcomes can be tracked, thereby achieving the purpose of harmony of knowledge and action.

Another objective of the present invention is that the validation program draws a radar chart for task score based on the student's execution score, the validation program also draws a pie chart for weekly completion rate, a pie chart for monthly completion rate, a pie chart for quarterly completion rate and a pie chart for total completion rate based on the task completion rate history of the student.

Another objective of the present invention is that the validation program can automatically post the execution score on the status wall of the webpage, and then rank execution scores of the students from high to low value.

Another objective of the present invention is that the task types of the task packages include video tasks, graphics tasks, quiz questions, tasks to be completed at specified locations, focus tasks, and tasks to be completed at preset times, and the displayed tasks includes a task description; during execution of the task, a task reminder animation is displayed to remind the student about the item to be executed in the next step within the preset time; after the students complete the tasks, the validation program validates whether the tasks are completed and then determines the execution scores for the completed tasks.

### BRIEF DESCRIPTION OF THE DRAWINGS

The structure, operating principle and effects of the present invention will be described in detail by way of various embodiments which are illustrated in the accompanying drawings.

FIG. 1 is a functional block diagram of a method for validating learning outcomes of student, according to the present invention.

FIG. 2 is a detailed functional block diagram of a teaching application stored in a memory storage unit, according to the present invention.

FIG. 3 is a flowchart of a method of validating learning outcomes of student, according to the present invention.

FIG. 4 is a first execution screen diagram of a teaching application of the present invention.

FIG. 5 is a second execution screen diagram of the teaching application of the present invention.

FIG. 6 is a third execution screen diagram of the teaching application of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

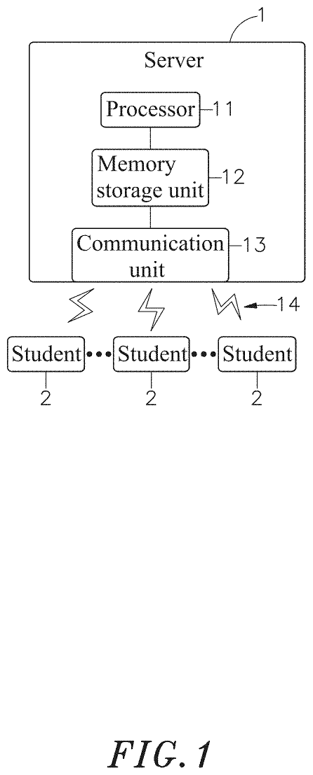

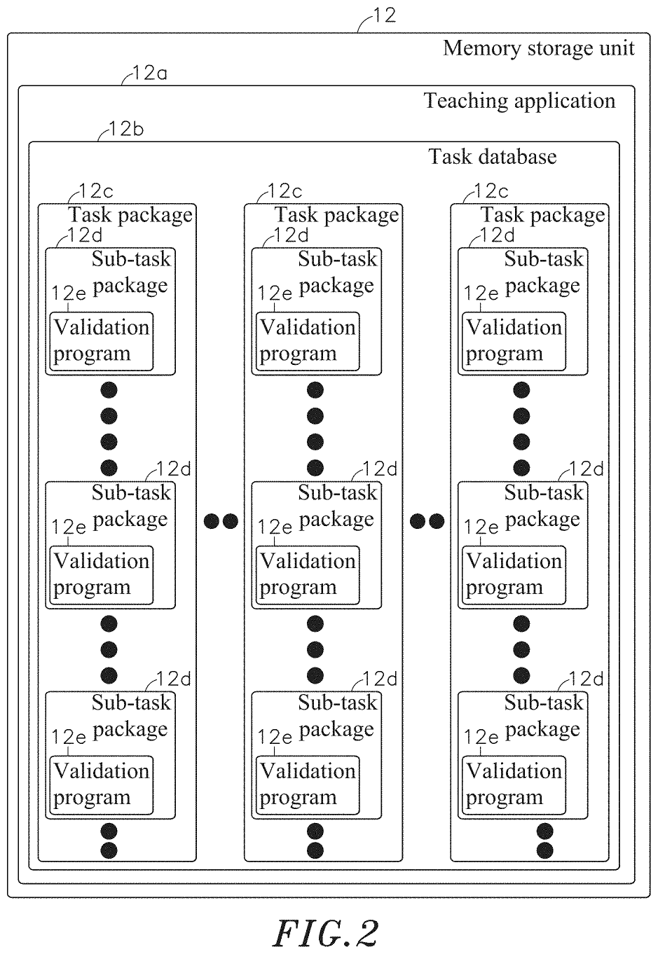

Please refer to FIGS. 1, 2, and 4 to 6. As shown in FIGS. 1, 2, and 4 to 6, the teaching tracking system includes a server 1 and a student 2, and the architecture of the teaching tracking system of the present invention is described in following paragraphs.

The server 1 includes a processor 11 and a memory storage unit 12, and the server 1 also includes a communication unit 13 configured for a plurality of students 2 to log in through network. The processor 11 executes a teaching application 12a stored in the memory storage unit 12, the teaching application 12a includes a task database 12b storing a plurality of task packages 12c. The task packages 12c correspond to teaching contents previously taught to the students by a coach. The ways of teaching courses include in-person lectures or online video lectures, and these examples are within the scope of implementation of the present invention. The task package 12c includes a sub-task package 12d configured for the student to execute task, and the sub-task package 12d includes a validation program 12e configured for acceptance of an execution result of the student 2 and statistics of an execution score and completion rate for the execution result. In an embodiment, the teaching application 12a can be a computer application software or a mobile phone application.

In an embodiment, the task packages 12c have diversity. For example, in the case of the same topic, the teaching application 12a executed by the processor 11 can assign different types of tasks (that is, the sub-task packages 12d) to a single student or a plurality of students by using pre-scheduled or random methods, so that the student can perform the task according to the sub-task package 12d and the validation program 12e can validate the execution score and the completion rate of the task, thereby achieving the diversity and versatility of teaching.

The students 2 can use electronic networking devices (not shown in figures) to log in through a wireless network 14. In an embodiment, the electronic networking device includes a personal computer, a notebook computer, a tablet computer, a smartphone, or a personal digital assistant; in an embodiment, the electronic networking device can include a global position system to record the position of the student 2. The wireless network 14 can be, for example, a mobile network or a wireless hotspot.

Furthermore, the student 2, who logs in through network, needs to edit a personal file. In an embodiment, the personal file records avatar, name, gender, nickname, user identity, relationship status, city, date of birth, and personal profile.

In an embodiment, the validation program 12e can include a timer module, a positioning module, a voice recording module, and a shooting module, and these modules are configured to perform comparison based on the task item and a preset execution standard score (not shown in figures) of the validation program 12e, so as to evaluate the execution result and determine an execution score and a completion rate for the execution result.

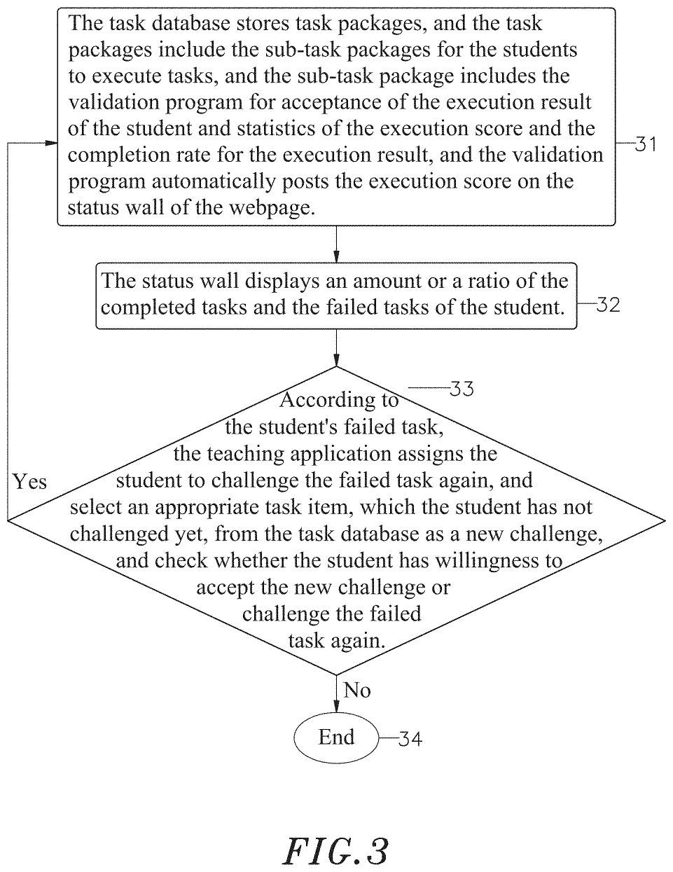

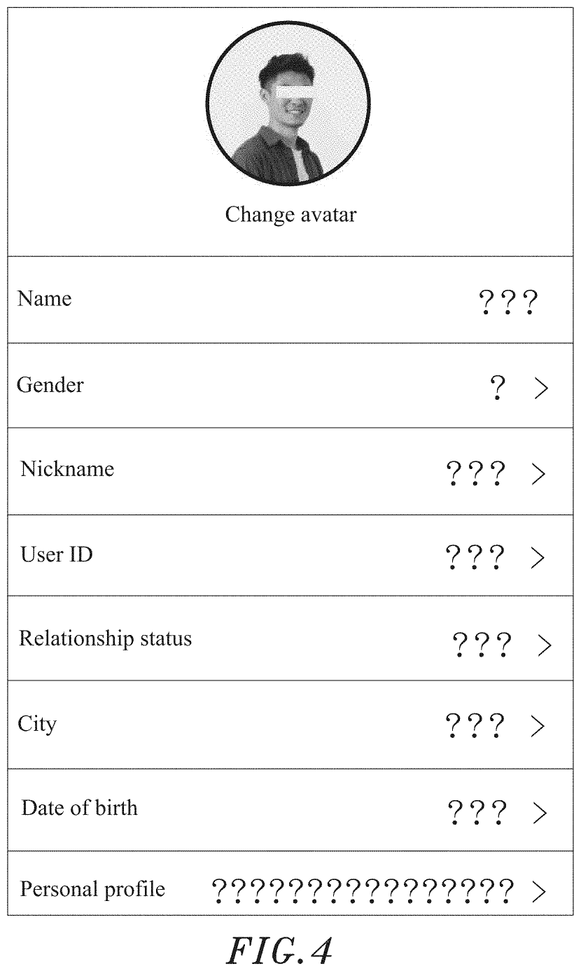

Please refer to FIG. 3, which is a flowchart of a method of validating learning outcomes of student, according to the present invention. As shown in FIG. 3 in reference with FIGS. 4 to 6, the teaching application executes the following steps 31 to 34.

In a step 31, the task database stores task packages, and the task packages include the sub-task packages configured for the students to execute tasks, and the sub-task package includes the validation program configured for acceptance of the execution result of the student and statistics of the execution score and the completion rate for the execution result, and the validation program automatically posts the execution score on the status wall (not shown in figures) of the webpage.

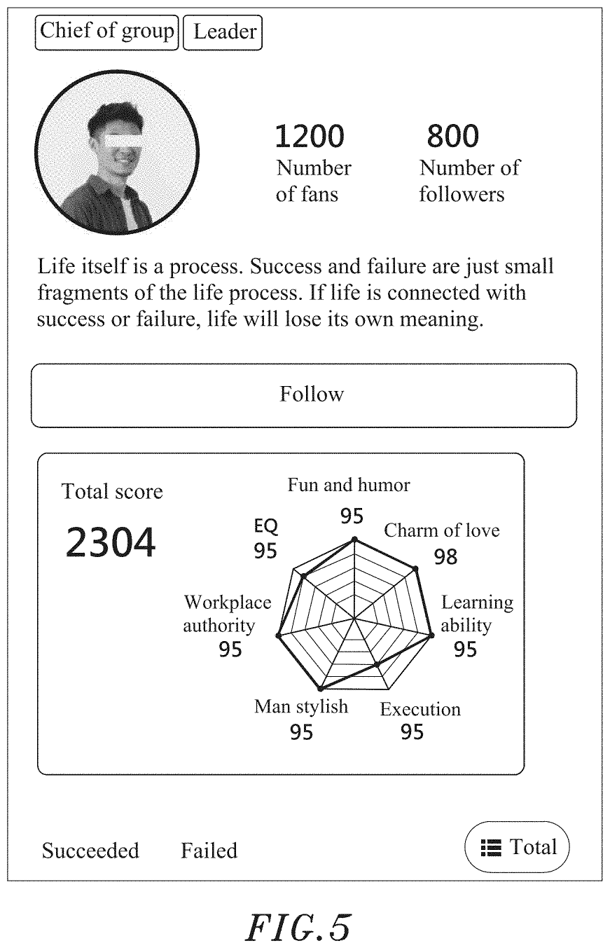

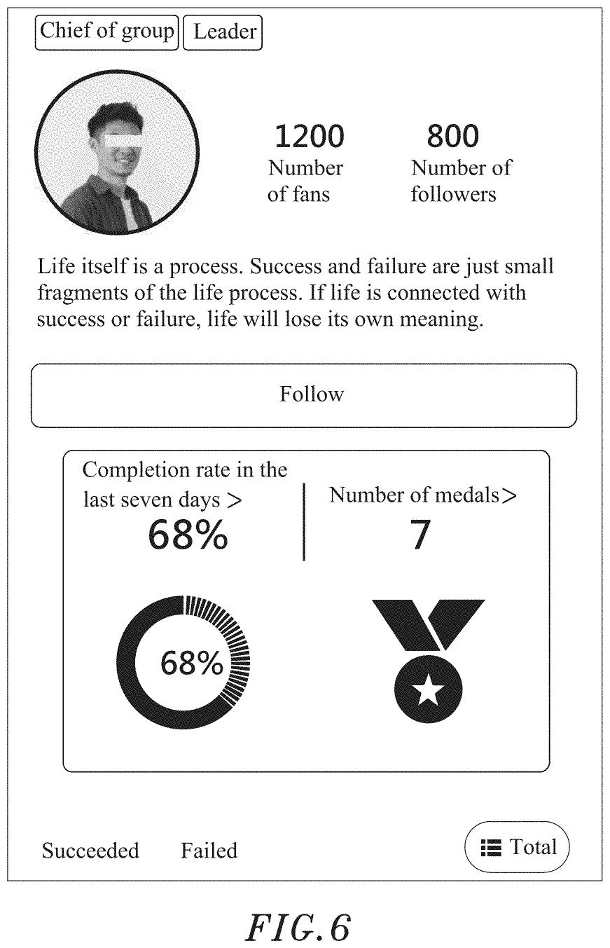

The validation program can draw a radar chart for task score (as shown in FIG. 5) based on the execution score of the student, and the validation program can draw a pie chart for weekly completion rate (as shown in FIG. 6), a pie chart for monthly completion rate (not shown in figures), a pie chart for quarterly completion rate (not shown in figures), and a pie chart for total completion rate (not shown in figures) based on the task completion rate history of the student.

The validation program can automatically post the execution score on the status wall of the webpage, and then rank the execution scores of the students from high to low values (not shown in figures). In an embodiment, the message box (not shown in figures) is disposed on the status wall and configured for students to leave messages.

The task types of the task packages can include, for example, video tasks, graphics tasks, quiz questions, tasks to be completed at specified locations, focus tasks, and tasks to be completed at preset times; these task types are not shown in figures. The displayed tasks include a task description, and during execution of the task, the task reminder animation is displayed to remind the student about the item to be executed in the next step within the preset time, and after the student completes the task, the validation program validates whether the tasks are completed and determines the execution scores for the completed tasks.

In a step 32, the status wall displays an amount or a ratio of the completed tasks and the failed tasks of the student.

In a step 33, according to the student's failed task, the teaching application can assign the student to challenge the failed task again, and select an appropriate task item, which the student has not challenged yet, from the task database as a new challenge, and then check whether the student has willingness to accept the new challenge or challenge the failed task again, and if yes, the step 31 is executed; otherwise, a step 34 is executed.

In a step 34, the operation flow of the method is ended.

According to the contents with reference to FIGS. 1 to 6, the present invention discloses the method of validating learning outcomes of student, and the validation program of the teaching application can determine the execution score and the completion rate for the student's execution result, and the teaching application includes the task database storing the task packages, and the task packages correspond to the teaching contents previously taught to the student by the coach, the task packages include the sub-task packages configured for the student to execute tasks, the sub-task package includes the validation program configured for acceptance of the student's execution result and statistics of an execution score and a completion rate for the execution result. According to the insufficiency of the student in response to the execution score and the completion rate displayed on the teaching application, the teaching application automatically assigns the student to challenge the failed task again or assigns a remedial task to the student, so as to improve the student in knowledge or skills learned in course. The execution score and the completion rate are posted on the status wall of the webpage, and the status wall includes the message box, so that student's peers can leave messages to cheer each other up. Therefore, the method of validating learning outcomes of the student can achieve the purpose of tracking learning outcomes after courses, and the purpose of harmony of knowledge and action can be achieved.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method of validating learning outcomes of student, wherein the method is applied to a server comprising a processor, a memory storage unit and a communication unit, and the communication unit is configured for a plurality of students to log in through network, the processor executes a teaching application, the teaching application is stored in the memory storage unit and comprises a task database, and the teaching application executes steps of:
(a): storing a plurality of task packages in the task database, wherein the plurality of task packages comprises sub-task packages configured for the students to execute a plurality of tasks, each of the sub-task packages comprises a validation program configured for acceptance of an execution result of one of the students and for statistics of an execution score and a completion rate of the execution result, and the validation program automatically posts the execution score on a status wall of a webpage; and
(b): displaying an amount or a ratio of completed tasks of one of the students on the status wall.

2. The method of validating learning outcomes of student according to claim 1, wherein the teaching application further executes a step:
(c): assigning one of the students to challenge a failed task again, selecting an appropriate task item, which one of the students has not challenged yet, from the task database as a new challenge, and determining whether one of the students has willingness to accept the new challenge or challenge the failed task again, and if yes, the step (a) is executed; otherwise, a step (d) is executed to end the method.

3. The method of validating learning outcomes of student according to claim 1, wherein in the step (a), the validation program draws a radar chart for task score based on an execution score of one of the students, and the validation program draws a pie chart for weekly completion rate, a pie chart for monthly completion rate, a pie chart for quarterly completion rate, and a pie chart for total completion rate based on a task completion rate history of one of the students.

4. The method of validating learning outcomes of student according to claim 1, wherein in the step (a), after the validation program automatically posts the execution score on the status wall of the webpage, the validation program ranks the execution scores of the students from high to low values, the status wall comprises a message box configured for the students to leave messages.

5. The method of validating learning outcomes of student according to claim 1, wherein in the step (a), task types of the task packages comprise video tasks, graphics tasks, quiz questions, tasks to be completed at specified locations, focus tasks, tasks to be completed at preset times, and the displayed tasks comprise a task description, and during execution of the task, a task reminder animation is displayed to remind the students about the item to be executed in the next step within the preset time, and after the students complete the tasks, the validation program validates whether the tasks are completed and determines execution scores for the completed tasks.

6. The method of validating learning outcomes of student according to claim 1, wherein in the step (b), the tasks stored in the task database comprise teaching contents previously taught to the students by a coach.

7. The method of validating learning outcomes of student according to claim 1, wherein in the step (b), the status wall displays an amount or a ratio of the failed tasks of the students.

8. The method of validating learning outcomes of student according to claim 1, wherein the students use electronic networking devices to log in through wireless network, the electronic networking devices comprise personal computers, notebook computers, tablet computers, smartphones, or personal digital assistants, and each of the electronic networking devices comprises a global position system configured to record positions of the students, and the wireless network is a mobile network or a wireless hotspot.

9. The method of validating learning outcomes of student according to claim 1, wherein each of the students needs to edit a personal file for log in through network, and the personal file comprises avatar, name, gender, nickname, user identity, relationship status, city, date of birth and personal profile.

10. The method of validating learning outcomes of student according to claim 1, wherein the validation program comprises a timer module, a positioning module, a voice recording module and a shooting module which are configured to perform comparison based on the task item and a preset execution standard score of the validation program, so as to evaluate the execution result and determine the execution score and the completion rate.
